(19) United States
(12) Patent Application Publication
(10) Pub. No.: US 2019/0217132 A1
(43) Pub. Date: Jul. 18, 2019

(54) Portable Respirator with Potential Equilibrium and Carbon Oxygen Exchange

(71) Applicant: Chun Man LAU, Hong Kong (HK)

(72) Inventor: Chun Man LAU, Hong Kong (HK)

(21) Appl. No.: 15/901,878

(22) Filed: Feb. 21, 2018

(30) Foreign Application Priority Data
Jan. 17, 2018 (CN) 201810045764.0

(51) Int. Cl. A62B 7/08; A62B 7/10; A62B 21/00; A62B 23/02

(52) U.S. Cl. CPC A62B 7/08; A62B 23/02; A62B 21/00; A62B 7/10

(57) ABSTRACT

The invention relates to a portable respirator with potential equilibrium and carbon oxygen exchange which includes a cover, a filtering device and an oxygen supply device. The cover is provided with a sealing ring, an elastomeric headband and a potential balancer. A plurality of fan-shaped filters are stacked in the cavity of the filtering device in a circumferential direction. The oxygen supply device includes a first tank and a second tank. The first tank is provided with a lithium battery, a miniature air pump and a reaction tank. A plurality of radiating copper pipes are circumferentially arranged on the outer wall surface of the first tank. A miniature liquid oxygen tank, an electric pressure reducing valve, a tension spring and an end cap are arranged in the second tank. One end of the miniature liquid oxygen tank is in contact with the end cap by the tension spring. The potential equilibrium and carbon oxygen exchange of the invention has advantages of having reasonable and simple structure, easy to use, small volume, light weight, and portability, etc., which effectively solves the problem of traditional respirators being inconvenient to be carried and used.

### FIELD OF THE INVENTION

The invention relates to fire-fighting equipment, and more particularly to a portable respirator with potential equilibrium and carbon oxygen exchange.

### BACKGROUND

Nowadays, respirators are widely used in fire protection, chemical industry, shipping, petroleum, smelting, warehousing, laboratories, mines and other departments. Respirators are mainly used to safely and effectively put out fire by firefighters, or do rescue and relief work by workers under the circumstances of strong smoke, toxic gas, steam or hypoxia. Traditional respirators include respiratory masks, gas cylinders, bottle tape sets, pressure reducer, back support and other components. Traditional respirators not only have tedious installation which affects the speed of entering the site, but also have big weight and large volume of overall equipment which has high physical requirement for users and is inconvenient to operate in narrow channels. Oxygen, as a good combustion-supporting gas, can ignite the people's clothes to cause danger, when people have potential difference in the body to result in static electricity. In the event of a fire, a conventional respirator cannot be used as a self-help tool for those who are not professionally trained, so it is necessary to develop a respirator that is small in size, light in weight and easy to carry and use.

### SUMMARY OF THE INVENTION

The technical problem to be solved is to overcome the above-mentioned deficiency by providing a portable respirator with potential equilibrium and carbon oxygen exchange. It has advantages of having reasonable and simple structure, easy to use, small volume, light weight, and portability, etc., which effectively solves the problem of traditional respirators being inconvenient to be carried and used.

The technical solution of the present invention is to provide a portable respirator with potential equilibrium and carbon oxygen exchange which includes a cover adapted to the shape of a nose and mouth, a filtering device and an oxygen supply device. The cover is fixedly arranged with a sealing ring. An elastomeric headband is disposed on the connecting piece that is symmetrically arranged on the cover. A potential balancer for balancing the potential of the human body is arranged on the cover. One end of the potential balancer is electrically connected with the electrode arranged in the inner cavity of the cover. The other end of the potential balancer is grounded through a wire, and the electrodes are in contact with the human body.

The filtering device is a hollow cylinder structure communicated with the cover. A plurality of fan-shaped filters are stacked in the cavity of the filtering device in a circumferential direction. The fan-shaped filter is coated with activated carbon impregnated with an antivirus agent. The fan-shaped filter is pressed to be fixed by a post rod in the axis of the cylinder.

The oxygen supply device includes a first tank that recovers carbon dioxide to produce oxygen and a second tank. One end of the first tank and one end of the second tank are respectively hinged with the cover. The first tank is provided with a lithium battery, a miniature air pump and a reaction tank filled with hydrogen peroxide powder. One end of the miniature air pump is interconnected with the inner cavity of the cover. The other end of the miniature air pump is penetrated into the reaction tank through an air guide tube. The reaction tank is provided with an outlet pipe that is interconnected with the inner cavity of the cover. The outlet pipe is connected with a serial of filter boxes filled with activated carbon. A plurality of radiating copper pipes are circumferentially arranged on the outer wall surface of the first tank.

A miniature liquid oxygen tank, an electric pressure reducing valve, a tension spring and an end cap are arranged in the second tank. One end of the miniature liquid oxygen tank is in contact with the end cap by the tension spring. The other end of the miniature liquid oxygen tank is connected to the inlet of the electric pressure reducing valve. The outlet of the electric pressure reducing valve is connected with the inner cavity of the cover.

As a preferred embodiment, the cover is made of aluminum alloy.

As a preferred embodiment, the cover is provided with glass fiber cloth for heat insulation.

As a preferred embodiment, the connecting piece and the cover are integrated.

As a preferred embodiment, the sealing ring is made of silica gel with a hollow structure, and the cavity is filled with gas.

As a preferred embodiment, a plurality of through holes are arranged on the wall of the air guide tube.

As a preferred embodiment, the first tank is provided with a switch for controlling the external power supply of the lithium battery.

As a preferred embodiment, both surfaces of the hollow cylinder structure are made of a mesh plate.

As a preferred embodiment, the lithium battery is respectively electrically connected with the miniature air pump and the electric pressure reducing valve. The lithium battery is provided with a charging and discharging control circuit with a USB charging port.

The technical effect of the invention is provide a portable respirator with potential equilibrium and carbon oxygen exchange which includes a cover adapted to the shape of a nose and mouth, a filtering device and an oxygen supply device. The cover is provided with a hollow sealing ring made of silica gel. The sealing ring is filled with gas to make the sealing ability stronger while reducing the constriction to users. The cover is provided glass fiber cloth with effective heat which prevents users from being burnt. The cover is also provided with a potential balancer for removing the potential difference to prevent the static electricity from causing fire. A plurality of fan-shaped filters are stacked in the cavity of the filtering device in a circumferential direction. When the pressure inside the cover is in a positive pressure state, the filter is pushed out to discharge the hot air. When the pressure inside the cover is in a negative pressure state, the filter is closed and is in the stage of filtration. Doing so can maintain the filtration efficiency and reduce the temperature in the cover. The oxygen supply device includes a first tank and a second tank. The first tank draws carbon dioxide gas from the cover into the reaction tank such that oxygen is produced. The second tank is provided with liquid oxygen to ensure the normal use of the respirator when the first tank cannot meet the oxygen supply. The first tank is provided with a switch that controls switch-on and switch-off of the respirator. It is convenient to use. It has advantages of having reasonable and simple structure, easy to use, small volume, light weight, and portability, etc., which effectively solves the problem of traditional respirators being inconvenient to be carried and used.

### BRIEF DESCRIPTION OF THE DRAWINGS

The invention is illustrated by the following figures and embodiments.

FIG. 1 shows a schematic diagram of whole structure of a portable respirator with potential equilibrium and carbon oxygen exchange in accordance with an embodiment.

FIG. 2 shows a side view of schematic diagram of a portable respirator with potential equilibrium and carbon oxygen exchange in accordance with an embodiment.

FIG. 3 shows a schematic diagram of a filtering device of a portable respirator with potential equilibrium and carbon oxygen exchange in accordance with an embodiment.

The reference numbers of the figures are as follows:

1: cover; 11: sealing ring; 12: connecting piece; 13: elastomeric headband; 14: potential balancer; 15: electrode; 2: filtering device; 21: fan-shaped filter; 22: post rod; 3: oxygen supply device; 31: first tank; 311: lithium battery; 3111: charging and discharging control circuit; 312: miniature air pump; 313: air guide tube; 314: reaction tank; 315: outlet pipe; 316: through hole; 317: switch; 318: filter box; 319: radiating copper pipe: 32: second tank; 321: miniature liquid oxygen tank; 322: electrical pressure reducing valve; 323: tension spring; 324: end cap

### DETAILED DESCRIPTION

The invention is illustrated in accordance with figures. The figures as simplified diagrams demonstrate the basic structures of the apparatus of embodiments of the invention. Thus, the invention is not limited to the figures.

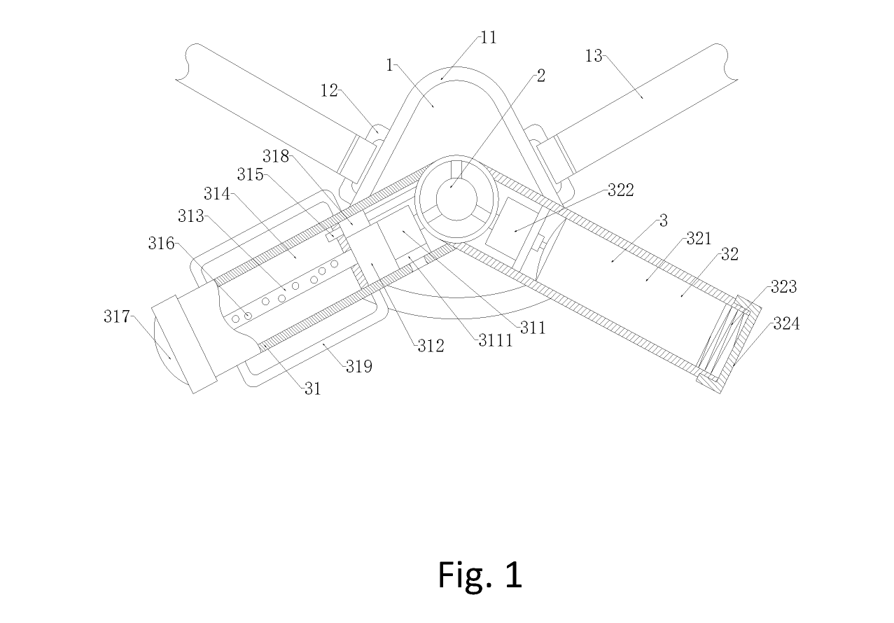

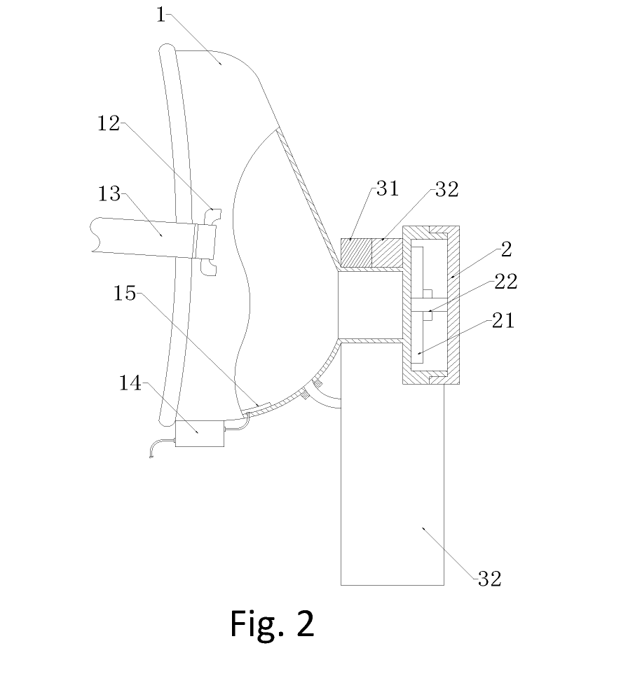

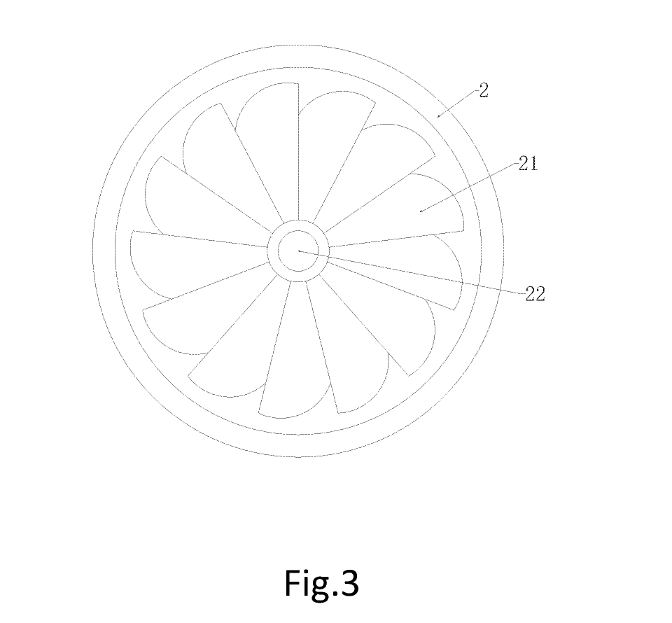

As shown in FIGS. 1, 2 and 3, a portable respirator with potential equilibrium and carbon oxygen exchange includes a cover 1 adapted to the shape of a nose and mouth, a filtering device 2 and an oxygen supply device 3. The cover 1 is fixedly arranged with a sealing ring 11. An elastomeric headband 13 is disposed on the connecting piece 12 that is symmetrically arranged on the cover 1. A potential balancer 14 for balancing the potential of the human body is arranged on the cover 1. One end of the potential balancer 14 is electrically connected with the electrode 15 arranged in the inner cavity of the cover 1. The other end of the potential balancer 14 is grounded through a wire, and the electrodes 15 are in contact with the human body.

The filtering device 2 is a hollow cylinder structure communicated with the cover 1. A plurality of fan-shaped filters 21 are stacked in the cavity of the filtering device 2 in a circumferential direction. The fan-shaped filter 21 is coated with activated carbon impregnated with an antivirus agent. The fan-shaped filter 21 is pressed to be fixed by a post rod 22 in the axis of the cylinder.

The oxygen supply device 3 includes a first tank 31 that recovers carbon dioxide to produce oxygen and a second tank 32. One end of the first tank 31 and one end of the second tank 32 are respectively hinged with the cover 1. The first tank 31 is provided with a lithium battery 311, a miniature air pump 312 and a reaction tank 314 filled with hydrogen peroxide powder. One end of the miniature air pump 312 is interconnected with the inner cavity of the cover 1. The other end of the miniature air pump 312 is penetrated into the reaction tank 314 through an air guide tube 313. The reaction tank 314 is provided with an outlet pipe 315 that is interconnected with the inner cavity of the cover 1. The outlet pipe 315 is connected with a serial of filter boxes 318 filled with activated carbon. A plurality of radiating copper pipes 319 are circumferentially arranged on the outer wall surface of the first tank 31.

A miniature liquid oxygen tank 321, an electric pressure reducing valve 322, a tension spring 323 and an end cap 324 are arranged in the second tank 32. One end of the miniature liquid oxygen tank 321 is in contact with the end cap 324 by the tension spring 323. The other end of the miniature liquid oxygen tank 321 is connected to the inlet of the electric pressure reducing valve 322. The outlet of the electric pressure reducing valve 322 is connected with the inner cavity of the cover 1.

The cover 1 is made of aluminum alloy. The cover 1 is provided with glass fiber cloth for heat insulation. The connecting piece 12 and the cover 1 are integrated. The sealing ring 11 is made of silica gel with a hollow structure, and the cavity is filled with gas. A plurality of through holes 316 are arranged on the wall of the air guide tube 313. The first tank 31 is provided with a switch 317 for controlling the external power supply of the lithium battery 311. Both surfaces of the hollow cylinder structure are made of a mesh plate. The lithium battery 311 is respectively electrically connected with the miniature air pump 312 and the electric pressure reducing valve 322. The lithium battery 311 is provided with a charging and discharging control circuit 3111 with a USB charging port.

The portable respirator with potential equilibrium and carbon oxygen exchange of the invention includes a cover adapted to the shape of a nose and mouth, a filtering device and an oxygen supply device. The cover is provided with a hollow sealing ring made of silica gel. The sealing ring is filled with gas to make the sealing ability stronger while reducing the constriction to users. The cover is provided glass fiber cloth with effective heat which prevents users from being burnt. The cover is also provided with a potential balancer for removing the potential difference to prevent the static electricity from causing fire. A plurality of fan-shaped filters are stacked in the cavity of the filtering device in a circumferential direction. When the pressure inside the cover is in a positive pressure state, the filter is pushed out to discharge the hot air. When the pressure inside the cover is in a negative pressure state, the filter is closed and is in the stage of filtration. Doing so can maintain the filtration efficiency and reduce the temperature in the cover. The oxygen supply device includes a first tank and a second tank. The first tank draws carbon dioxide gas from the cover into the reaction tank such that oxygen is produced. The second tank is provided with liquid oxygen to ensure the normal use of the respirator when the first tank cannot meet the oxygen supply. The first tank is provided with a switch that controls switch-on and switch-off of the respirator. It is convenient to use. It has advantages of having reasonable and simple structure, easy to use, small volume, light weight, and portability, etc., which effectively solves the problem of traditional respirators being inconvenient to be carried and used.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A portable respirator with potential equilibrium and carbon oxygen exchange, comprising:
a cover 1 adapted to the shape of a nose and mouth;
a filtering device 2 and an oxygen supply device 3,
wherein the cover 1 is fixedly arranged with a sealing ring 11; an elastomeric headband 13 is disposed on the connecting piece 12 that is symmetrically arranged on the cover 1; a potential balancer 14 for balancing the potential of the human body is arranged on the cover 1; one end of the potential balancer 14 is electrically connected with the electrode 15 arranged in the inner cavity of the cover 1; the other end of the potential balancer 14 is grounded through a wire, and the electrodes 15 are in contact with the human body,
wherein the filtering device 2 is a hollow cylinder structure communicated with the cover 1; a plurality of fan-shaped filters 21 are stacked in the cavity of the filtering device 2 in a circumferential direction; the fan-shaped filter 21 is coated with activated carbon impregnated with an antivirus agent; the fan-shaped filter 21 is pressed to be fixed by a post rod 22 in the axis of the cylinder; the filtering device 2 is a hollow cylinder structure communicated with the cover 1; a plurality of fan-shaped filters 21 are stacked in the cavity of the filtering device 2 in a circumferential direction; the fan-shaped filter 21 is coated with activated carbon impregnated with an antivirus agent; the fan-shaped filter 21 is pressed to be fixed by a post rod 22 in the axis of the cylinder,
wherein the oxygen supply device 3 includes a first tank 31 that recovers carbon dioxide to produce oxygen and a second tank 32; one end of the first tank 31 and one end of the second tank 32 are respectively hinged with the cover 1; the first tank 31 is provided with a lithium battery 311, a miniature air pump 312 and a reaction tank 314 filled with hydrogen peroxide powder; one end of the miniature air pump 312 is interconnected with the inner cavity of the cover 1; the other end of the miniature air pump 312 is penetrated into the reaction tank 314 through an air guide tube 313; the reaction tank 314 is provided with an outlet pipe 315 that is interconnected with the inner cavity of the cover 1; the outlet pipe 315 is connected with a serial of filter boxes 318 filled with activated carbon; a plurality of radiating copper pipes 319 are circumferentially arranged on the outer wall surface of the first tank 31,
wherein a miniature liquid oxygen tank 321, an electric pressure reducing valve 322, a tension spring 323 and an end cap 324 are arranged in the second tank 32; one end of the miniature liquid oxygen tank 321 is in contact with the end cap 324 by the tension spring 323; the other end of the miniature liquid oxygen tank 321 is connected to the inlet of the electric pressure reducing valve 322; the outlet of the electric pressure reducing valve 322 is connected with the inner cavity of the cover 1.

2. The portable respirator with potential equilibrium and carbon oxygen exchange of claim 1, wherein the cover 1 is made of aluminum alloy.

3. The portable respirator with potential equilibrium and carbon oxygen exchange of claim 1, wherein the cover 1 is provided with glass fiber cloth for heat insulation.

4. The portable respirator with potential equilibrium and carbon oxygen exchange of claim 1, wherein the connecting piece 12 and the cover 1 are integrated.

5. The portable respirator with potential equilibrium and carbon oxygen exchange of claim 1, wherein the sealing ring 11 is made of silica gel with a hollow structure, and the cavity is filled with gas.

6. The portable respirator with potential equilibrium and carbon oxygen exchange of claim 1, wherein a plurality of through holes 316 are arranged on the wall of the air guide tube 313.

7. The portable respirator with potential equilibrium and carbon oxygen exchange of claim 1, wherein the first tank 31 is provided with a switch 317 for controlling the external power supply of the lithium battery 311.

8. The portable respirator with potential equilibrium and carbon oxygen exchange of claim 1, wherein both surfaces of the hollow cylinder structure are made of a mesh plate.

9. The portable respirator with potential equilibrium and carbon oxygen exchange of claim 1, wherein the lithium battery 311 is respectively electrically connected with the miniature air pump 312 and the electric pressure reducing valve 322; the lithium battery 311 is provided with a charging and discharging control circuit 3111 with a USB charging port.
